(19) United States
(12) Patent Application Publication
(10) Pub. No.: US 2004/0059592 A1
(43) Pub. Date: Mar. 25, 2004

(54) System and method of contractor risk assessment scoring system (CRASS) using the internet, and computer software

(76) Inventor: Rani Yadav-Ranjan, San Jose, CA (US)

Correspondence Address: Rani K. Yadav-Ranjan, 18730 Vista De Almaden, San Jose, CA, 95120, US

(21) Appl. No.: 10/623,352

(22) Filed: Jul. 17, 2003

Related U.S. Application Data
(60) Provisional application No. 60/397,539, filed on Jul. 23, 2002.

(51) Int. Cl. G06F 17/60

(52) U.S. Cl. 705/1; 705/36

(57) ABSTRACT

This invention disclosure deals with a system and method with the process of automatically assessing the Risk associated with Construction Contractors (Contractor Risk Assessment Scoring System (CRASS)). The method comprises steps (a) implemented a computer software which features steps to create an information database including information elements, (b) provide mined Contractor data to automate valuation model system, (c) receiving Contractor valuation data from Public and Private Entities, (d) determining a maximum allowable score by applying a pre-set valuation data, and (e) automatically carrying out in the computer system using software. The computer system for automatically processing the Score is disclosed. The invention may utilize a user interface, a server, and a communication pathway to electronically solicit, receive, and store contractor information.

### FIELD OF THE INVENTION

The present invention is directed generally to a system and method for predicting the Contractorworthiness and, more specifically, to a system and method for calculating or deriving a score that is predictive of a future worthiness of a Contactor.

### BACKGROUND OF THE INVENTION

The problem of how to adequately score a contractor is challenging, often requiring the application of complex and highly technical actuarial transformations. The technical difficulties with scoring coverage's are compounded by real world pressures such as the need to maintain an “ease-of-business-use” process with Contractors and the financial pricings by competitors attempting to buy market share.

In the construction industry, there are no approaches for determining the appropriate risk associated with a contractor for a specific job. The underlying exposure to the individual or business and related losses can be based on certain characteristics or practices of the contractor.

The current approach is based on intangible factors such as word-of-mouth, references, number of employees and time in business. These intangible factors are qualitative and, for the most part, are not easily capable of measurement. Under a less practiced “semi-quantitative” approach, the final determination of the risk is made by certain characteristics of the business owner and the business itself. For example, the score may depend on how many liens the Contractor has outstanding versus liens settled.

Despite the availability of alternative “semi-quantitative” methodologies, the construction regulatory system is based primarily on word-of-mouth, while relegating the business owner characteristic aspect of pricing to underwriting judgment and expertise. Thus, in the current marketplace little practical emphasis is placed on the Contractor's overall characteristics in evaluating for risk worthiness.

In addition, the construction industry has not effectively included the use of external data sources in the estimation of the risk of a contractor, or in other words, the determination of an appropriate score for a particular contractor. External data sources offer one of the best opportunities to obtain the characteristics of an individual contactor and or the practices of the construction business, which is essential for practicing the second approach to assessment as described above. While commercial financial lenders have occasionally looked to non-traditional factors to supplement their conventional assessment methods, such use has been at best haphazard, inconsistent and usually relegated to a subjective perspective. In the commercial financial industry, theses practices have resulted in pricing methods that, although occasionally using non-traditional factors, are generally specific to the data.

Accordingly, a need exists for a system and method that performs a complete Risk assessment evaluation that does not rely on conventional methodologies. A still further need exists for such a system and method that utilizes external data sources to generate a generic statistical model that is predictive of a Risk Assessment Score. A still further need exists for such a system and method that can be used to augment the risk associated with construction to quantitatively include through the use of external data sources business owners' characteristics and other non-exposure-based characteristics.

In view of the foregoing, the present invention provides a quantitative system and method that employs data sources external to a Contractor to either independently or more accurately and consistently report data on a per contractor basis. The present system and method reporting mechanism using a statistical model that is developed from external data sources independent of a particular contactors internal data and particular pricing methodology.

### SUMMARY OF THE INVENTION

This invention disclosure teaches about a system and method in which a construction project manager has a model for how risk is distributed. The Risk Assessment issue will bring into question the amount of risk that others are willing to take on. For example, today if a construction project is considered one of the most difficult, frustrating and challenging thing is to find an acceptable contractor. One honest, worthy and competent to complete the project under consideration. To do this one starts with asking neighbors, friends, colleagues or advertisements. All these methods take time and resources. The risk factor has not been eliminated and the experience with each project differs depending on the Contractor. This scoring system would eliminate this step by generating a score for each contractor. The database would hold the scores of each contractor, which could then be used by peers, consumers and financial lenders to aid in the decision making process. The consumer could go the database and get the score for each contractor they would consider using. The risk factor would be eliminated thereby assuring the successful completing of the Construction project, on time and within the budget. This will also regulate an industry which has no measurable metric in place for assessment for all licensed contractors.

### BRIEF DESCRIPTION OF THE DRAWINGS

For a fuller understanding of the invention, references are made to the following description, taken in connection with the accompanying drawings, in which:

FIG. A1 is a flow diagram depicting the steps carried out in actuarially receiving Contractor and Permit data and identifying predictive external variable preparatory to developing a statistical score that allows Licenses and Individuals a measurable score in accordance with a preferred embodiment of the present invention

FIG. A2 is a flow diagram depicting the data mined or carried out in developing the model and calculating a score

FIG. A3 is a flow diagram of a system according to an exemplary embodiment of the present invention with respect to the incoming Data via a Secure Socket Layer and Security Firewall

FIG. A4 is a flow diagram of system according to an exemplary embodiment of the present invention

Table 1 is a Table showing predictive Value assigned to Data variable preparatory that predicts Contractor Risk in accordance with a preferred embodiment of the present invention

Example 1-4 is tables showing a possible score scenarios using CRASS.

### DETAILED DESCRIPTION OF THE PREFERRED EMBODIMENTS

The present invention is directed to the creation of a predictive statistical model that generates a score representative of the Contractor future worthiness independent of the internal data including the steps of (i) gathering historical contractor data from one of a entities listed, e.g., County Department of Official Records (Grantor/Grantee), County Building Permit Department, County Factitious Business, City Building Permit Department, State Department of Records and Licenses, County Judicial Records which may maintain historical data required by statutory reporting requirements, and the like, and then storing such historical contractor data in a database; (ii) identifying external data sources having a plurality of external variables potentially predictive of contractor worthiness, each variable preferable having at least two values; (iii) normalizing the historical contactor data using actuarial transformations to generate working data; (iv) calculating a loss ratio for each contractor in the database using the working data; (v) using the working data to calculate a cumulative risk ratio for each potentially predictive external variable value; (vi) analyzing one or more external variables to identify significant statistical relationships between the one or more external variables and the cumulative risk ratio; (vii) identifying and choosing predictive external variables based on statistical significance and the determination of highly experienced actuaries and statisticians; (viii) utilizing the various predictive variables to develop an overall model or algorithm predictive of the Contractor worthiness; and (ix) scoring new or existing Contractors using the predictive statistical model as developed herein.

In accordance with another aspect of the invention the external sources are selected from a group comprised of business level databases (e.g., Dun & Bradstreet and FICO score companies), and entity level databases (e.g., County Department of Official Records (Grantor/Grantee), County Building Permit Department, County Factitious Business, City Building Permit Department, State Department of Records and Licenses, County Judicial Records) and Financial Lender level database.

In accordance with yet another aspect of the invention, the database includes historical Risk score on a plurality of Contractors from one or more of the possible historical Contractor data sources.

Accordingly, it is an object of the present invention to provide a system and method that employs data sources external to a Contractor to develop a statistical model that is predictive of Contractor worthiness, independent of the internal data of a particular Contractor. Other objects and advantages of the invention will in part be obvious and will impart be apparent from the specification.

The present invention accordingly comprises the various steps and the relation of one or more of such steps with respect to each of the others and the product which embodies features of construction, combinations of elements, and arrangement of parts which are adapted to effect such steps, all as exemplified in the following detailed disclosure, and the scope of the invention will be indicated in the claims.

The future worthiness can be defined as an assessment, on a prospective basis, of whether Contractor is going to be able to finish the Construction job on time, and on budget, and with preset quality methodologies using standard and traditional methods established. The data collection and aggregation, and more particularly to collecting Contractor performance data from a limited number of entities uploading data directly from installed software applications, aggregating such data at a central location, and generating reports and/or alerts based on the aggregated data.

Contractor Risk Assessment Score is a system with data from many different types of exposure. These include several government agencies, e.g., County Department of Official Records (Grantor/Grantee), County Building Permit Department, County Factitious Business, City Building Permit Department, State Department of Records and Licenses, County Judicial Records, Financial and Lending Institution. There are many other specialty information and many more types of sub-information within the major lines of public information.

Ideally, a Risk Manager would associate a monetary cost based on a Contractors Score. The monetary cost should be a function of the loss potential which can never be completely known in advance, hence the introduction of risk. The more accurate assessment of that risk, the more certainty of profitability of the Contractor. The Score of the Contractor reflects the risk associated with him/her. That is, the higher the score the lower the risk and should be assessed as such while lower scores should be held with great caution for the construction job.

The present invention is a quantitative algorithm that employs data sources external to generate a statistical model that maybe used to predict Contractor Risk Assessment Score (CRAS). The CRAS will be based on multivariate algorithmic approach. Subsequent descriptions herein will utilize a multivariate weightage algorithmic approach as the basis of the description of the underlying methodology of developing the model and its associated structure.

FIGS.: 1 thru 3.6 are now described in more detail.

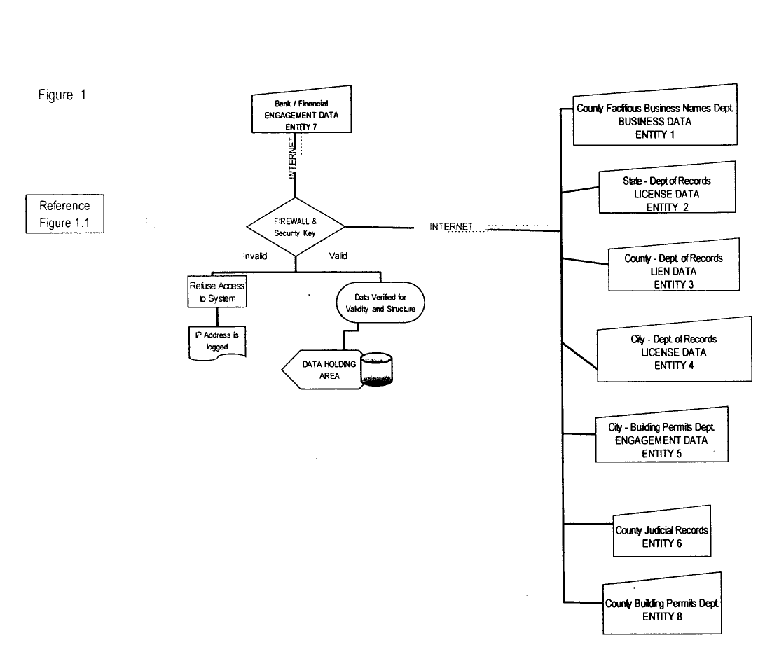

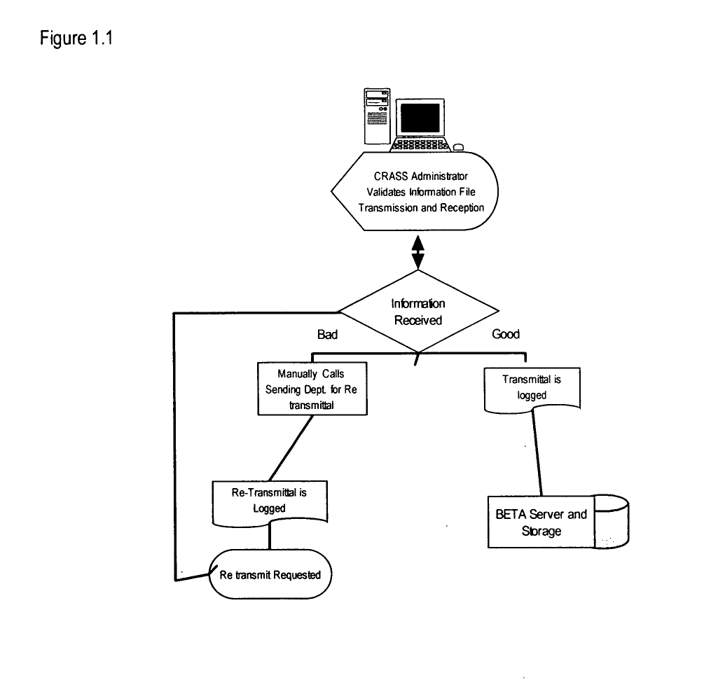

FIG. 1: References is first made to FIG. A1, which generally depicts the steps in the process preparatory to developing the algorithmic formula based on Contractor associated data collected. The system is comprised of gathering data from external databases then running it thought the Algorithm to achieve the score. This represents the macro view of the Company's data collecting and validating structure.

Included in this Figure is the list of Public Entities where the data will be mined and built into a transmitting file. Each entity will be set up on a variable time schedule for extraction of the data file. Entity 1: County Factitious Business Names Department will be mined for Business Data pertaining to a Contractor. Entity 2: State, Department of Records focusing on Contractor License Data. Entity 3: County Department of Official Records, focus on Lien Data (Grantor/Grantee Index). Entity 4: City Department of Records, focus on Business Licensing. Entity 5: City Building Permits Department focus on Engagement Data for each permit pulled per construction project. Entity 6: County Judicial Records focus on Individual Contractor Information. Entity 7: Bank/Financial Institutions focus on Engagement Data pertaining to a loan for completion of a Construction Project.

FIG. 1.1 generally depicts the steps in the process preparatory for the CRASS Administrator to validate information file and log information pertaining to the transmission and reception of the data files from the above mentioned Entities. The computer system does a test dump of the data file. If the information received is good, then the transmittal file is logged and the data is sent to the BETA server for storage and assimilation. If the information file is corrupted or bad then the Administrator has to phone the Entity to re-transmit the data file.

The administrator also logs the session and sets up a temporary receptacle for the data file. The CRAS Administrator monitors activity and traffic flow for data transmissions for the external data files coming into the Database Holding area. He also, checks Digital Certificate for Server ID to make sure that the proper clearance has been given and validates the external data.

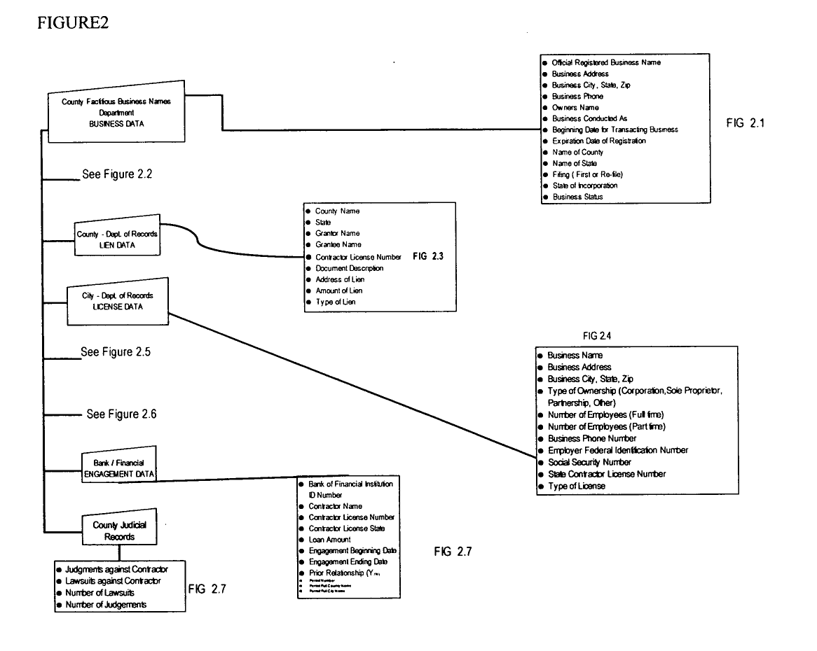

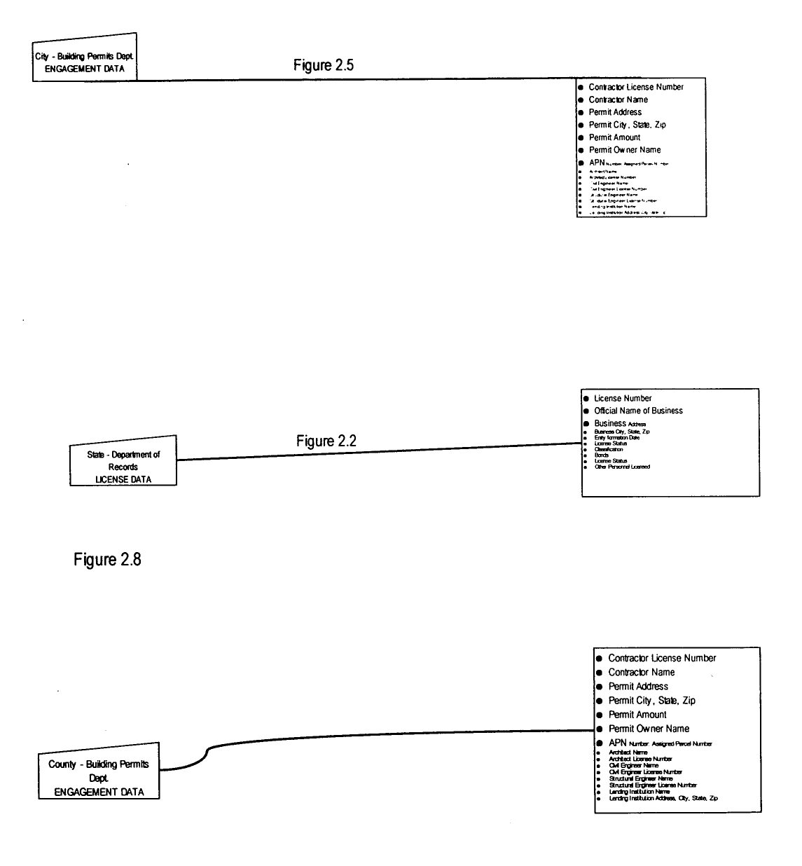

FIG. 2 generally depicts the information received from the Entities mentioned above.

FIG. 2.1 depicts the information received from Entity 1: County Factitious Business Names Department will be mined for Business Data pertaining to a Contractor, sending the following: a) Official Registered Business Name; b) Business Address; c) business City, State, ZIP code; d) Business Phone; e) Applicant's name; f) Business conducted as status; g) Beginning date for transacting business; h) Expiration Date of Registration; i) Name of County; j) Name of State; k) Filling (First or Re-file) each county has unique rules applying to the length of a license to conduct business is valid; l) State of Incorporation; m) Business status focus on Partnership, Sole Proprietor or Corporation.

FIG. 2.2 depicts the information received from Entity 2: State Department of Records focus Contractor License Data. Data mined will include a) Contractor License Number; b) Official Name of Business; c) Business Address; d) Business City, State, ZIP Code; e) Enity formation Date; f) License Status; g) Classification; h) Bond amounts; i) License Status (Active/In-active/Suspended); j) Other personnel Licensed.

FIG. 2.3: Entity 3: County Department of Official Records focus on Lien Data (Grantor/Grantee Index). Data mined will include a) County Name; b) State in which the county is located; c) Grantor Name; d) Grantee Name; e) Contractor License Number; f) Address of Lien; g) Amount of Lien; h) Type of Lien.

FIG. 2.4 Entity 4: City Department of Records will be mined for Business Data pertaining to a Contractor. a) City Name; b) Business Name; c) Business Address; d) Business City, State, Zip code; e) Type of Ownership (Corporation, Sole Proprietor, Partnership, Other); f) Number of Employees (working Full Time); g) Number of Employees (working Part Time); h) Business Phone Number; i) Employer Identification Number; j) Social Security Number for Sole Proprietor; k) State Contractor License Number; m) Type of License (Ref. License Codes Table).

FIG. 2.5 Entity 5: City-Building Permits Department focus on Engagement Data stream will be mined for a) Contractor License Number; b) Contractor Name; c) Permit Address; d) Permit City, State, Zip Code; e) Permit Amount; f) Permit Owner Name; g) APN Number: Assigned Parcel Number; h) Architect Name; i) Architect License Number; j) Civil Engineer Name; k) Civil Engineer License Number; l) Structural Engineer Name; m) Structural Engineer License Number; n) Lending Institution Name; o) Lending Institution Address, City, State, ZIP Code.

FIG. 2.6 Entity 6: County Building Permits Department focus on Engagement Data will be mined for a) Contractor License Number; b) Contractor Name; c) Permit Address; d) Permit City, State, Zip Code; e) Permit Amount; f) Permit Owner Name; g) APN Number: Assigned Parcel Number; h) Architect Name; i) Architect License Number; j) Civil Engineer Name; k) Civil Engineer License Number; l) Structural Engineer Name; m) Structural Engineer License Number; n) Lending Institution Name; o) Lending Institution Address, City, State, ZIP Code.

FIG. 2.7 Entity 7: Bank and/or Financial Institution focus on Engagement Data will be mined for a) Bank or Financial Institution ID (Routing Number); b) Contractor Business Name; c) Contractor License Number; d) Contractor License State name; e) Loan Amount; f) Engagement Beginning Date; g) Engagement Ending Date; h) Prior Relationship with Contractor (Y/N)—has the bank borrowed money to borrowers who have employed the Contractor. i) Permit Number; j) Permit Pull County Name; k) Permit pull city name (name of the city which authorized the Permit for proposed construction project).

FIG. 2.8 Entity 8: County Judicial Records Department focus on Contractor Stability will be mined for a) Judgments against Contractor; b) Lawsuits against Contractor; c) Number of Lawsuits; d) Number of Judgments.

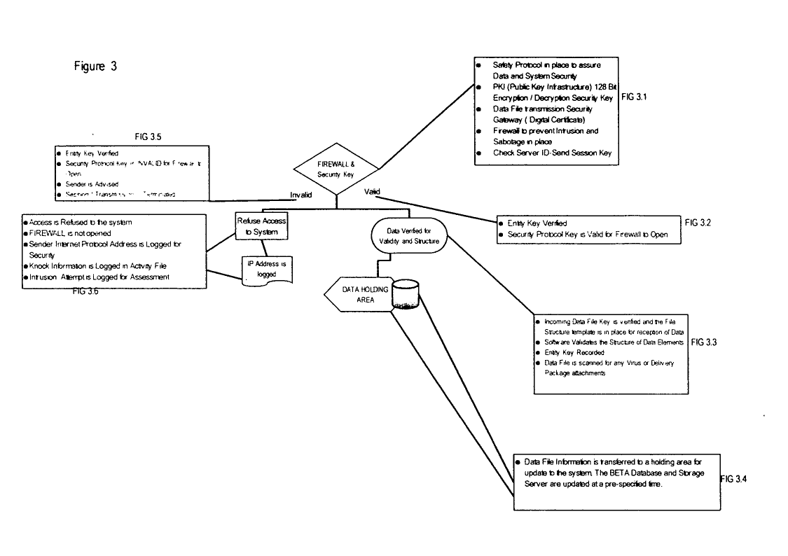

FIG. 3: If the Public Entity key is Invalid the system will refuse access and the senders IP address will be logged for further use.

FIG. 3.1 Firewall & Security Key Module checks the Public data transmitted thru the Internet gaining access thru the Firewall with valid Security Key, accessing the company Storage Hard Drives and depositing the data file. The PKI is coded at the Maximum level. Data File Transmission Security Gateway is active with the authorized Digital Certificate generated from the Certificate Authority, such as Verisign or Trust-e. Firewall to active to prevent intrusion and sabotage is in place. The server checks the id of an approaching actor and sends Session Key upon validation.

FIG. 3.2 Valid Security Key Module checks the data for Validity and Structure using the Company Database tables as guidelines. The Security Protocol Key is Valid for Firewall to Open for Transmission of the Data file from specified Entity.

FIG. 3.3 Data Structure Module is scanned for any Virus or Delivery Package attachments for disrupting the Software system(Intranet). The module checks incoming data key and the file structure templates are valid. The software also validates the structure of the Data Elements and records the Entity Key in a log file.

FIG. 3.4 Data Holding Module moves the File information transferred into a Data Holding area for compilation into the image database files/tables. The BETA Database and Storage Server are updated at a pre-specified time interval.

FIG. 3.5 Invalid KEY is entered and verified by the system. Security Protocol key is recorded and sender is advised, session/transmission is terminated.

FIG. 3.6 Safety Module is activated. Access is denied to the system and the Senders Internet Protocol Address is logged and reported to security for further checking. Knock information is logged in a Session Activity file. The Intrusion attempt is Logged for Assessment.

Using the Weightage table below one can develop the score based on the values assigned to each category.

TABLE 1

| CRASS | VALUE |
|---|---|
| Length of License | LEN LIC |
| 0 | 1 |
| 1 | 1 |
| 2 | 5 |
| 3 | 10 |
| 4 | 15 |
| 5 | 20 |
| 6 | 25 |
| 7 | 30 |
| 11 | 35 |
| 16 | 40 |
| 21 | 45 |
| 26 | 50 |
| Number of Employees | NUM EMP |
| 0 | 0 |
| 1 | 1 |
| 3 | 5 |
| 8 | 10 |
| 14 | 15 |
| 21 | 20 |
| 36 | 25 |
| 51 | 30 |
| 71 | 35 |
| 101 | 40 |
| 201 | 45 |
| 301 | 50 |
| Avg. Length of Engagement | AVG ENG |
| 0 | 0 |
| 3 | 5 |
| 6 | 15 |
| 9 | 30 |
| 12 | 40 |
| 18 | 50 |
| Cum. # of Engagements | CUM ENG |
| 0 | 0 |
| 1 | 1 |
| 4 | 5 |
| 9 | 10 |
| 14 | 15 |
| 20 | 20 |
| 26 | 25 |
| 36 | 30 |
| 51 | 35 |
| 66 | 40 |
| 81 | 45 |
| 101 | 50 |
| License Status | LIC STA |
| 0 | |
| Suspended | 0 |
| 1 Inactive | 10 |
| 2 Active | 40 |
| Number of Banks | NUM BAK |
| 0 | 0 |
| 1 | 10 |
| 2 | 20 |
| 3 | 30 |
| 4 | 40 |
| 5 | 50 |
| Number of Tax Liens | NUM TXL |
| 0 | 50 |
| 1 | 30 |
| 2 | 10 |
| 3 | 0 |
| Number of NOC | NOC |
| 0 | 0 |
| 1 | 1 |
| 4 | 5 |
| 9 | 10 |
| 14 | 15 |
| 20 | 20 |
| 26 | 25 |
| 36 | 30 |
| 51 | 35 |
| 66 | 40 |
| 81 | 45 |
| 101 | 50 |
| Number of Liens | NUM LEN |
| 0 | 50 |
| 1 | 40 |
| 4 | 30 |
| 10 | 20 |
| 15 | 10 |
| 20 | 0 |
| Terminations/yr. In Bus. | PER LIC |
| 0 | 50 |
| 0.01 | 40 |
| 1 | 30 |
| 2 | 20 |
| 3 | 10 |
| 4 | 0 |
| 5 | 0 |
| Delays/Engagements | PRG DLY |
| 0 | 50 |
| 0.11 | 40 |
| 0.21 | 30 |
| 0.25 | 20 |
| 0.5 | 10 |
| 0.75 | 0 |
| Number of Terminations | TERM |
| 0 | 50 |
| 1 | 40 |
| 2 | 35 |
| 3 | 30 |
| 6 | 20 |
| 8 | 10 |
| 10 | 0 |
| Current Engagements | NUM ENG |
| 0 | 0 |
| 1 | 5 |
| 2 | 10 |
| 3 | 25 |
| 4 | 40 |
| 5 | 50 |
| NOC/Engagements | PER NOC |
| 0 | 0 |
| 0.11 | 5 |
| 0.21 | 10 |
| 0.31 | 15 |
| 0.41 | 20 |
| 0.51 | 30 |
| 0.71 | 40 |
| 0.91 | 50 |
| Terminations/Engagements | PER TRM |
| 0 | 50 |
| 0.01 | 40 |
| 0.11 | 30 |
| 0.26 | 20 |
| 0.51 | 10 |
| 0.76 | 0 |
| Avg. Size of Engagement | AVG ENG |
| 0 | 0 |
| 100 | 10 |
| 250 | 20 |
| 500 | 30 |
| 750 | 40 |
| 1000 | 50 |
| Re-Structure | RES LIC |
| 1 Sole-to-Partnership | 0 |
| 2 Partnership-to-Corp | 15 |
| 3 Sole-to-Corp. | 30 |
| Insurance/Total Value | INS LVA |
| 0 | 0 |
| 0 | 10 |
| 0.6 | 20 |
| 0.7 | 30 |
| 0.8 | 40 |
| 1 | 50 |
| Repeat Business with Bank | REP BAK |
| 0 No | 0 |
| 1 Yes | 50 |
| Structure | SCC |
| None | 0 |
| 1 Sole | 0 |
| 2 Partnership | 15 |
| 3 Corp | 30 |
| License Type | LIC TYP |
| 0 No | 0 |
| 1 Yes | 20 |
| Age of Contractor | CON AGE |
| 0 | 0 |
| 18 | 0 |
| 22 | 10 |
| 26 | 30 |
| 31 | 40 |
| 36 | 50 |
| 41 | 35 |
| 46 | 30 |
| 51 | 27 |
| 56 | 25 |
| 61 | 20 |

```
Foreign Activities
0 = 50
1 = 40
2 = 30
3 = 20
4 = 10
5 = 0
Previous Request
0 Yes = 0
1 No = 30
Foreign Countries Visited
    0 = 60
  1-2 = 50
  3-6 = 40
  7-9 = 30
10-12 = 20
13-15 = 10
  16+ = 0
Police Record
0 Yes = 0
1 No = 40
Military Record
0 Yes = 30
1 No = 0
Military Release
0 W/Honor = 50
1 W/O Honor = 0
2 Forced = 0
```

The normalized data creates a data stream including. One example of the formula for CRAS is the following:

CRAS=[ε(Ai)/ε(Mi)*100]

where Ai=Assigned score on variable i; and Mi=maximum score on variable i. The cumulative ratio is calculated for a defined Contractor. The cumulative Contractor Risk Assessment Score is defined, for example, as the sum of (length-of-license) plus (Cumulative-total-of-engagements) plus (number-of-Notice-of-completions) plus (Number-of-terminations) plus (Current-engagements) plus (Insurance-held divided by Total-value-of-engagement) plus (Company-structure) plus (number-of-employees) plus (years-in-trade) plus (number-of-liens) plus (Number-of-banks-used) plus (Terminations divided by Yeas-in-Business) plus (Terminations divided by Total-Engagements) plus (Delays divided by Total-Engagements) plus (Number-of-Tax-Liens) plus (Age-of-Contractor) plus (License-Type) plus (License-Status) plus (Repeat Business-with-Bank) plus (Average-size-of-Engagement) plus (Judgments) plus (Judgments-satisfied divided by Total-Number-of-Judgments) plus (Restructure of Company) plus (Number-previous-Licenses-Held) plus (Avg.-Monetary-size-proj.) plus (DB-FICO ratio)) plus Sensitivity Level or Public Trust Risk Level (SL_PTRL) plus Security Clearance Score (SCC).

Example (1), using the table above one if

Structure of Contractor (SCC)=3 then the value for CRAS is 30 +

Type of License (LIC_TYP)=1 then the value for CRAS is 20; +

License Status (LIC_STA)=1 then the value for CRAS is 20; +

Restructure of Status (CON_LIC)=0 value assigned by CRAS is 0 +

Number of Employees (NUM_EMP)=24 then the value assigned by CRAS is 25; +

Cumulative # of Engagements (CUM_ENG)=56 then the value assigned by CRAS is 35; +

Previous License Held (LIC_HLD)=Yes or (No), value assigned is 50; +

Length of License in Years (LEN_LIC)=16, value assigned is 40 +

Number of Banks with Relationships (REP_BAK)=5 the assigned value by CRAS is 50, +

Repeat business with Bank (REP_BAK)=(Yes) or No, value assigned is 40 +

Contractor Age (AGE_CON)=36 value assigned is 50 +

Insurance for Loss/Value of Engagements (INS_LVE)=1 value assigned is 50 +

Number of Current Engagements (NUM_ENG)=5 value assigned is 50 +

Average length of Engagement (AVG_ENG)=14(Months) value assigned is 40 +

Average Monetary size of Project (AVEW_$EN)=543 (K) value assigned

Number of Terminations (NUM_TER)=2 value assigned is 35 +

Number of Termination/Cumulative Engagement (PER_NOC)=4% (Derived value) table value assigned 40 +

Number of Terminations/Yrs Licensed (PER_LIC)=0.13 (Derived value) table value assigned 40 +

Percent of Projects Delayed (PRG_DLY)=0.13 (Derived value) calculated by (Total_Permits_pulled/NOC Filed) value assigned 40 +

Number of Liens (NUM_LIN)=3 table value assigned 40 +

Number of Tax Liens (NUM_TXL)=1 table value assigned 30 +

D&B or FICO (DB_FIC)=530 (Derived value) table value assigned 13

Total CRASS determination of Contractor ability=778.

EXAMPLE 1

CN Score Sheet

| | | |
|---|---|---|
| Contractor Name | License # | Lic. State |

| Parameter | CODE | VALUE | MAX. SCORE | CN SCORE | Valid VALUES |
|---|---|---|---|---|---|
| Structure | | | | | |
| Structure of Contractor Company | SCC | 3 | 30 | 30 | Sole = 1, Partner = 2, Corp = 3 |
| License Status | LIC_STA | 1 | 40 | 20 | Suspended = 0, Inactive = 10 |
| | | | | | Active = 40 |
| Type of License | LIC_TYP | 1 | 20 | 20 | no = 0, Yes= 1 |
| Restructure of Company Status | CON_LIC | 0 | 30 | 0 | None = 0, Sole/Part = 10 |
| | | | | | Part/Corp = 30, Sole/Corp = 30 |
| Size of Contractor Business | | | | | |
| # of Employees | NUM_EMP | 24 | 50 | 25 | >0 |
| Cumulative # of Engagements | CUM_ENG | 56 | 50 | 35 | >0 |
| Stability | | | | | |
| Previous Licenses Held | LIC_HLD | 0 | 50 | 50 | 0 = 50, 1 = 25, 2 = 0 |
| Length of License in Years | LEN_LIC | 16 | 50 | 40 | >0 |
| # of Banks Relationship with | NUM_BAK | 5 | 50 | 50 | >0 |
| Repeat business with Banks | REP_BAK | 1 | 50 | 50 | No = 0, Yes = 1 |
| Age of Contractor | AGE_CON | 36 | 50 | 50 | >18 for sole, for others = 36 |
| Insurance for Loss/Value of | IN_LVE | 1 | 50 | 50 | |
| Engagements | | | | | |
| Engagements | | | | | |
| # of current engagements | NUM_ENG | 5 | 50 | 50 | >0 |
| Avg. Length of engagement | AVG_ENG | 14 | 50 | 40 | >0 |
| Avg. Monetary size of project | AVE_#EN | 543 | 50 | 30 | >0 |
| Performance | | | | | |
| # of Terminations | NUM_TER | 2 | 50 | 35 | >0 |
| # of terminations/CUM_ENG | PER_NOC | 4% | 50 | 40 | derived value |
| Number of Terminations/yrs. In Trade | PER_LIC | 0.13 | 50 | 40 | derived value |
| Percentage of Projects Delayed | PRG_DLY | 0.13 | 50 | 40 | >0 |
| Financial | | | | | |
| # of Liens filed against Contractor | NUM_LIN | 3 | 50 | 40 | >0 |
| # of Tax liens | NUM_TXL | 1 | 50 | 30 | >0 |
| Other credit ratings | | | | | |
| D & B score/FICO score | DB_FIC | 530 | 22 | 13 | >0, max DB = 686, FICO = 850 |
| | | CNSCORE | 992 | 778 | |

Example (2), using the table above one if

Structure of Contractor (SCC)=3 then the value for CRAS is 30 +

Type of License (LIC_TYP)=0 then the value for CRAS is 20; +

License Status (LIC_STA)=2 then the value for CRAS is 20; +

Restructure of Status (CON_LIC)=0 value assigned by CRAS is 0 +

Number of Employees (NUM_EMP)=16 then the value assigned by CRAS is 15; +

Cumulative # of Engagements (CUM_ENG)=14 then the value assigned by CRAS is 15; +

Previous License Held (LIC_HLD)=Yes or (No), value assigned is 50; +

Length of License in Years (LEN_LIC)=4, value assigned is 15 +

Number of Banks with Relationships (REP_BAK)=4 the assigned value by CRAS is 30, +

Repeat business with Bank (REP_BAK)=(Yes) or No, value assigned is 50 +

Contractor Age (AGE_CON)=36 value assigned is 50 +

Insurance for Loss/Value of Engagements (INS_LVE)=1 value assigned is 50 +

Number of Current Engagements (NUM_ENG)=4 value assigned is 40 +

Average length of Engagement (AVG_ENG)=11 (Months) value assigned is 30 +

Average Monetary size of Project (AVEW_$EN)=437 (K) value assigned 20 +

Number of Terminations (NUM_TER)=0 value assigned is 50 +

Number of Termination/Cumulative Engagement (PER_NOC)=0% (Derived value) table value assigned 50 +

Number of Terminations/Yrs Licensed (PER_LIC)=0.0 (Derived value) table value assigned 50 +

Percent of Projects Delayed (PRG_DLY)=0.0 (Derived value) calculated by (Total_Permits_pulled/NOC Filed) value assigned 50 +

Number of Liens (NUM_LIN)=1 table value assigned 40 +

Number of Tax Liens (NUM_TXL)=0 table value assigned 50 +

D&B or FICO (DB_FIC)=530 (Derived value) table value assigned 13

Total CRASS determination of Contractor ability=738.

EXAMPLE 2

CN Score Sheet

| | | |
|---|---|---|
| Contractor Name | License # | Lic. State |

| Parameter | CODE | VALUE | MAX. SCORE | CN SCORE | Valid VALUES |
|---|---|---|---|---|---|
| Structure | | | | | |
| Structure of Contractor Company | SCC | 3 | 30 | 30 | Sole = 1 , Partner = 2, Corp = 3 |
| License Status | LIC_STA | 2 | 40 | 20 | Suspended = 0, Inactive = 10 |
| | | | | | Active = 40 |
| Type of License | LIC_TYP | 0 | 20 | 20 | no = 0, Yes = 1 |
| Restructure of Company Status | CON_LIC | 0 | 30 | 0 | None = 0, Sole/Part = 10 |
| | | | | | Par/Corp = 30, Sole/Corp = 30 |
| Size of Contractor Business | | | | | |
| # of Employees | NUM_EMP | 16 | 50 | 15 | >0 |
| Cumulative # of Engagements | CUM_ENG | 14 | 50 | 15 | >0 |
| Stability | | | | | |
| Previous Licenses Held | LIC_HLD | 0 | 50 | 50 | 0 = 50, 1 = 25, 2 = 0 |
| Length of License in Years | LEN_LIC | 4 | 50 | 15 | >0 |
| # of Banks Relationship with | NUM_BAK | 4 | 50 | 30 | >0 |
| Repeat business with Banks | REP_BAK | 1 | 50 | 50 | No = 0, Yes = 1 |
| Age of Contractor | AGE_CON | 36 | 50 | 50 | >18 for sole, for others = 36 |
| Insurance for Loss/Value of | INS_LVE | 1 | 50 | 50 | |
| Engagements | | | | | |
| Engagements | | | | | |
| # of current engagements | NUM_ENG | 4 | 50 | 40 | >0 |
| Avg. Length of engagement | AVG_ENG | 11 | 50 | 30 | >0 |
| Avg. Monetary size of project | AVE_#EN | 437 | 50 | 20 | >0 |
| Performance | | | | | |
| # of Terminations | NUM_TER | 0 | 50 | 50 | >0 |
| # of terminations/# of Projects | PER_NOC | 0% | 50 | 50 | derived value |
| Number of Terminations/yrs. In Trade | PER_LIC | 0 | 50 | 50 | derived value |
| Percentage of Projects Delayed | PRG_DLY | 0 | 50 | 50 | >0 |
| Financial | | | | | |
| # of Liens filed against Contractor | NUM_LIN | 1 | 50 | 40 | >0 |
| # of Tax liens | NUM_TXL | 0 | 50 | 50 | >0 |
| Other credit ratings | | | | | |
| D & B score/FICO score | DB_FIC | 530 | 22 | 13 | >0, max DB = 686, FICO = 850 |
| | | CNSCORE | 992 | 738 | |

Example (3), using the table above one if

Structure of Contractor (SCC)=1 then the value for CRAS is 0 +

Type of License (LIC_TYP)=1 then the value for CRAS is 20; +

License Status (LIC_STA)=2 then the value for CRAS is 40; +

Restructure of Status (CON_LIC)=0 value assigned by CRAS is 0 +

Number of Employees (NUM_EMP)=10 then the value assigned by CRAS is 10; +

Cumulative # of Engagements (CUM_ENG)=14 then the value assigned by CRAS is 15; +

Previous License Held (LIC_HLD)=Yes or (No), value assigned is 50; +

Length of License in Years (LEN_LIC)=8, value assigned is 30 +

Number of Banks with Relationships (REP_BAK)=5 the assigned value by CRAS is 50, +

Repeat business with Bank (REP_BAK)=(Yes) or No, value assigned is 40 +

Contractor Age (AGE_CON)=32 value assigned is 50 +

Insurance for Loss/Value of Engagements (INS_LVE)=1 value assigned is 50 +

Number of Current Engagements (NUM_ENG)=2 value assigned is 10 +

Average length of Engagement (AVG_ENG)=9(Months) value assigned is 30 +

Average Monetary size of Project (AVEW_$EN)=234 (K) value assigned 10 +

Number of Terminations (NUM_TER)=0 value assigned is 50 +

Number of Termination/Cumulative Engagement (PER_NOC)=0% (Derived value) table value assigned 50 +

Number of Terminations/Yrs Licensed (PER_LIC)=0.0 (Derived value) table value assigned 50 +

Percent of Projects Delayed (PRG_DLY)=0.0 (Derived value) calculated by (Total_Permits_pulled/NOC Filed) value assigned 50 +

Number of Liens (NUM_LIN)=0 table value assigned 50 +

Number of Tax Liens (NUM_TXL)=0 table value assigned 50 +

D&B or FICO (DB_FIC)=520 (Derived value) table value assigned 13 +

Total CRASS determination of Contractor ability=703.

EXAMPLE 3

CN Score Sheet

| | | |
|---|---|---|
| Contractor Name | License # | Lic. State |

| Parameter | CODE | VALUE | MAX. SCORE | CN SCORE | Valid VALUES |
|---|---|---|---|---|---|
| Structure | | | | | |
| Structure of Contractor Company | SCC | 1 | 30 | 0 | Sole = 1 , Partner = 2, Corp = 3 |
| License Status | LIC_STA | 2 | 40 | 40 | Suspended = 0, Inactive = 10 |
| | | | | | Active = 40 |
| Type of License | LIC_TYP | 1 | 20 | 20 | no = 0, Yes = 1 |
| Restructure of Company Status | CON_LIC | 0 | 30 | 0 | None = 0, Sole/Part = 10 |
| | | | | | Part/Corp = 30, Sole/Corp = 30 |
| Size of Contractor Business | | | | | |
| # of Employees | NUM_EMP | 10 | 50 | 10 >0 | |
| Cumulative # of Engagements | CUM_ENG | 14 | 50 | 15 | >0 |
| Stability | | | | | |
| Previous Licenses Held | LIC_HLD | 1 | 50 | 25 | 0 = 501 = 25,2 = 0 |
| Length of License in Years | LEN_UC | 8 | 50 | 30 | >0 |
| # of Banks Relationship with | NUM_BAK | 5 | 50 | 50 | >0 |
| Repeat business with Banks | REP_BAK | 1 | 50 | 50 | No = 0, Yes = 1 |
| Age of Contractor | AGE_CON | 32 | 50 | 50 | >18 for sole, for others = 36 |
| Insurance for Loss/Value of | INS_LVE | 1 | 50 | 50 | |
| Engagements | | | | | |
| Engagements | | | | | |
| # of current engagements | NUM_ENG | 2 | 50 | 10 | >0 |
| Avg. Length of engagement | AVE_ENG | 9 | 50 | 30 | >0 |
| Avg. Monetary size of project | AVE_#EN | 234 | 50 | 10 | >0 |
| Performance | | | | | |
| # of Terminations | NUM_TER | 0 | 50 | 50 | >0 |
| # of terminations/# of Projects | PER_NOC | 0% | 50 | 50 | derived value |
| Number of Terminations/yrs. In Trade | PER_NOC | 0 | 50 | 50 | derived value |
| Percentage of Projects Delayed | PRG_DLV | 0 | 50 | 50 | >0 |
| Financial | | | | | |
| # of Liens filed against Contractor | NUM_LIN | 50 | 50 | >0 | |
| # of Tax liens | NUM_TXL | 0 | 50 | 50 | >0 |
| Other credit ratings | | | | | |
| D & B score/FICO score | DB_FIC | 520 | 22 | 13 | >0, max DB = 686, FICO = 850 |
| | | CNSCORE | 992 | 703 | |

Example (4), using the table above one if

Structure of Contractor (SCC)=2 then the value for CRAS is 0 +

Type of License (LIC_TYP)=1 then the value for CRAS is 20; +

License Status (LIC_STA)=2 then the value for CRAS is 40; +

Restructure of Status (CON_LIC)=3 value assigned by CRAS is 30 +

Number of Employees (NUM_EMP)=29 then the value assigned by CRAS is 20; +

Cumulative # of Engagements (CUM_ENG)=33 then the value assigned by CRAS is 25; +

Previous License Held (LIC_HLD)=Yes or (No), value assigned is 30; +

Length of License in Years (LEN_LIC)=11, value assigned is 35 +

Number of Banks with Relationships (REP_BAK)=4 the assigned value by CRAS is 40, +

Repeat business with Bank (REP_BAK)=(Yes) or No, value assigned is 50 +

Contractor Age (AGE_CON)=40 value assigned is 50 +

Insurance for Loss/Value of Engagements (INS_LVE)=1 value assigned is 50 +

Number of Current Engagements (NUM_ENG)=4 value assigned is 40 +

Average length of Engagement (AVG_ENG)=11 (Months) value assigned is 30 +

Average Monetary size of Project (AVEW_$EN)=347 (K) value assigned

Number of Terminations (NUM_TER)=2 value assigned is 35 +

Number of Termination/Cumulative Engagement (PER_NOC)=6% (Derived value) table value assigned 40 +

Number of Terminations/Yrs Licensed (PER_LIC)=0.17 (Derived value) table value assigned 40 +

Percent of Projects Delayed (PRG_DLY)=0.25 (Derived value) calculated by (Total_Permits_pulled/NOC Filed) value assigned 20 +

Number of Liens (NUM_LIN)=3 table value assigned 40 +

Number of Tax Liens (NUM_TXL)=0 table value assigned 50 +

D&B or FICO (DB_FIC)=520 (Derived value) table value assigned 13

Total CRASS determination of Contractor ability=718.

EXAMPLE 4

CN Score Sheet

| | | |
|---|---|---|
| Contractor Name | License # | Lic. State |

| Parameter | CODE | VALUE | MAX. SCORE | CN SCORE | Valid VALUES |
|---|---|---|---|---|---|
| Structure | | | | | |
| Structure of Contractor Company | SCC | 2 | 30 | 0 | Sole = 1, Partner = 2, Corp = 3 |
| License Status | LIC_STA | 2 | 40 | 40 | Suspended = 0, Inactive = 10 |
| | | | | | Active = 40 |
| Type of License | LIC_TYP | 1 | 20 | 20 | no = 0, Yes = 1 |
| Restructure of Company Status | CON_LIC | 3 | 30 | 30 | None = 0, Sole/Part =10 |
| | | | | | Part/Corp = 30, Sole/Corp = 30 |
| Size of Contractor Business | | | | | |
| # of Employees | NUM_EMP | 29 | 50 | 20 | >0 |
| Cumulative # of Engagements | CUM_ENG | 33 | 50 | 25 | >0 |
| Stability | | | | | |
| Previous Licenses Held | LIC_HLD | 0 | 50 | 30 | 0 = 50, 1 = 25, 2 = 0 |
| Length of License in Years | LEN_LIC | 11 | 50 | 35 | >0 |
| # of Banks Relationship with | NUM_BAK | 4 | 50 | 40 | >0 |
| Repeat business with Banks | REP_BAK | 1 | 50 | 50 | No = 0, Yes = 1 |
| Age of Contractor | AGE_CON | 40 | 50 | 50 | >18 for sole, for others = 36 |
| Insurance for Loss/Value of | INS_LVE | 1 | 50 | 50 | |
| Engagements | | | | | |
| Engagements | | | | | |
| # of current engagements | NUM_ENG | 4 | 50 | 40 | >0 |
| Avg. Length of engagement | AVG_ENG | 11 | 50 | 30 | >0 |
| Avg. Monetary size of project | AVE_#EN | 347 | 50 | 20 | >0 |
| Performance | | | | | |
| # of Terminations | NUM_TER | 2 | 50 | 35 | >0 |
| # of terminations/# of Projects | PER_NOC | 6% | 50 | 40 | derived value |
| Number of Terminations/yrs. In Trade | PER_LIC | 0.17 | 50 | 40 | derived value |
| Percentage of Projects Delayed | PRG_DLY | 0.25 | 50 | 20 | >0 |
| Financial | | | | | |
| # of Liens filed against Contractor | NUM_LIN | 3 | 50 | 40 | >0 |
| # of Tax liens | NUM_TXL | 0 | 50 | 50 | >0 |
| Other credit ratings | | | | | |
| D & B score/FICO score | DB_FIC | 520 | 22 | 13 | >0, max DB = 686, FICO = 850 |
| | | CNSCORE | 992 | 718 | |

EXAMPLE 5

### CRASS Report

| | | | | |
|---|---|---|---|---|
| CONTRACTOR NAME: | ROOFING SAN INC | LIC. ISSUE DATE: | Jul. 21, 1989 | |
| ADDRESS: | CRISTICH LANE | RE-ISSUE DATE: | | |
| | CAMPBELL, CA 95008 | LIC. EXP. DATE: | Apr. 01, 1994 | |
| BUSINESS PHONE | | CNAV SCORE: | 322 | |
| NUMBER: | | | | |
| CONTRACTOR LICENSE: | 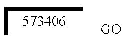 | PREVIOUS LICENSE #: | | |
| | | PREVIOUS LIC. | | |
| | | EXP DATE: | | |
| COMPANY STRUCTURE: | CORPORATION | LICENSE ISSUE DATE: | | |
| CITY BUSINESS LIC.# | NO LIC ON FILE EXP: | PREVIOUS NAME: | | |
| NUMB OF EMPLOYEES: | | OLD ADDRESS: | | |
| COUNTY FICTITIOUS | 358913 EXP: | OLD CITY, STATE, ZIP: | | |
| FICTITIOUS BIZ | | | | |
| OWNERS NAME: | | | | |
| OWNERS/RMO NAME: | | PREVIOUS RMO/ | | |
| | | OWNER: | | |
| CELL: | | | | |
| FAX: | | | | |
| CITATION | | | | |
| INFORMATION: | | | | |
| WORKMAN'S INS. | | PREVIOUS WORKMAN'S | | |
| NAME: | INSURER: | | | |
| WORKMAN'S POLICY | | PREVIOUS WORKMAN'S | | |
| #: | | POLICY # | | |
| INSURANCE EFFECTIVE | | EFFECTIVE DATE: | | |
| DATE: | | CANCELLATION DATE: | | |
| PERMIT PULL DATE/ | SITE ADDRESS | OWNER | | |
| JOB HISTORY: | CITY NAME | CITY, ZIP | NAME | VALUATION |
| | Jan. 30, 2003 | | | $34,000.00 |
| | CAMPBELL | | | |
| | Jan. 30, 2003 | | | $27,200.00 |
| | CAMPBELL | | | |
| | Jan. 30, 2003 | | | $20,390.00 |
| | CAMPBELL | | | |

Where the data gathered to build CRASS can be used to identify contractors who are unlicensed and conducting business.

EXAMPLE 6

[image]

This example shows individuals acting as Builders who pull permits. The CRASS would be affected only if a builder was not listed. The Owner/Builder is open to use CRASS to self manage this project.

EXAMPLE 7

| | | | |
|---|---|---|---|
| CONTRACTOR REPORT | LIEN INFO REPORT | VIOLATIONS/ACTIONS | AGENCY HOME PAGE |
| VALUATION REPORT | JOB HISTORY REPORT | PERSONAL ASSET REPORT | cNav SCORE REPORT |

| | | |
|---|---|---|
| INSURANCE COMPANY:STATE INSURANCE FUND | POLICY NUMBER:100000000000 | EFFECTIVE DATE: |
| | | Feb. 1, 2002 |
| | CNAV SCORE: 605 | EXPIRATION DATE: |
| | | Oct. 1, 2003 |

| | | |
|---|---|---|
| LICENSE PRIMARY STATUS: | ACTIVE | |
| LICENSE SECONDARY STATUS: | | |
| CONTRACTOR LICENSE: | | PREVIOUS LICENSE #: |
| LICENSE EXP. DATE: | | PREVIOUS LIC. EXP DATE: |
| LICENSE ISSUE DATE: | | LICENSE ISSUE DATE: |
| NAME: | | PREVIOUS NAME: |
| ADDRESS: | | ODL ADDRESS: |
| CITY, STATE, ZIP: | | OLD CITY, STATE, ZIP: |
| COMPANY STRUCTURE: | CORPORATION | OLD COMPANY STRUCTURE: |
| CITY BUSINESS LIC. #: | 2367 EXP: Oct. 31, 2003 | OLD CITY NAME: |
| NUMB OF EMPLOYEES: | 3 AS OF: Mar. 30, 2003 | FEES PAID TO CITY: |
| CITY BUSINESS ADDRESS: | | |
| COUNTY FICTITIOUS LICENSE | 381167 EXP: Jun. 16, 2005 | COUNTY NAME: |
| #: | | FEES PAID TO COUNTY: |
| DRIVERS LICENSE NUMBER: | EXP: | |
| HOME ADDRESS: | | DATE OF BIRTH: |
| OWNERS/RMO NAME: | | PREVIOUS RMO/OWNER: |
| PHONE: | | PREVIOUS WORKMAN'S |
| | | INSURER: |
| CELL: | | PREVIOUS POLICY # |
| FAX: | | EFFECTIVE DATE -CANCEL DATE: |

| | | | | |
|---|---|---|---|---|
| LIEN INFORMATION: | DATE | COUNTY | RECORD # | GRANTOR/GRANTEE |
| JUDGMENTS, TAX LIENS, | | | NAME | |
| PRE-LIENS, | | | | |
| MECHANIC'S LIENS, | | | | |
| MISC. | | | | |
| INSURANCE VIOLATIONS: | DATE/AGENT NAME | VIOLATION | FOLLOW-UP | COMMENTS/ACTIONS |

This example shows data gathered for CRASS in a different query. The contractor can be profiled show all previous and current business information as well as employment/job history. This example can be used by Workman's Compensation Fraud Division or City/State Finance Departments to assess loss of revenue.

EXAMPLE 9

JOB HISTORY REPORT

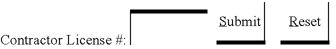

| 800216 | BETTER BUILT INC. | 730 SECOND STREET | | |
|---|---|---|---|---|
| JOB | PERMIT PULL DATE/ | SITE ADDRESS | GILROY, CA 95020 | OWNER: BRAIN ESLICK |
| HISTORY: | NOC FILED | CITY, ZIP | VALUATION | OWNER NAME |
| | Dec. 01, 2002 | 100 MAIN STREET | $450.00 | B & K ICK |
| | Dec. 10, 2002 | GILROY 95020 | | |
| | Jun. 12, 2002 | 232 MAIN STREET | $18,000.00 | |
| | Nov. 05, 2002 | GILROY 95020 | | |
| | Jul. 02, 2001 | 180 VISTA | $920,000.00 | R & R ANJA |
| | Dec. 30, 2001 | SAN JOSE 95111 | | |
| | Jan. 10, 2001 | | $35,000.00 | KFC INC. |
| | Jun. 12, 2001 | SAN JOSE 95118 | | |

This example show a detail Construction Job history for a contractor. This report can be used by any law enforcement agencies to target violations as well as large corporations who manage there own facilities.

EXAMPLE 10

PERSONAL ASSETS REPORT
8002161 BETTER BUILT INC. 730 SECOND STREET GILROY, CA 95020 OWNER: BRAIN ESLICK

| LENDING | NAME/ | LOAN | SITE | OWNER'S |
|---|---|---|---|---|
| INSTITUTIONS: | ADDRESS | AMOUNT | ADDRESS | NAME |
| | HERITAGE BANK OF | $1,634,000.00 | 180 VISTA | R & R ANJA |
| | COMMERCE | | SAN JOSE, CA | |
| | 150 ALMADEN BLVD | | | |
| | SAN JOSE, CA | | | |
| PERSONAL ASSETS: | DATE | AMOUNT | COMPANY NAME | COMMENTS |
| | May 28, 1999 | | WASHINGTON MUTUAL BK (E) | DEED OF TRUST |
| | | | | (MTGE/SECUR INSTR) |

This report can be used by Child welfare agencies and other government agencies. The CRASS database uses the data stored with Artificial Intelligence to generate this report.

To begin the process Contractor Business data is collected from one or more of the data sources and stored in a database in a step as Contractor records. Contractor License data is collected from one or more of the data sources and is stored in a database. Contractor Lien Data is collected from one or more of the data sources and stored in a database. Contractor Engagement Data is collected from one or more of the data sources and stored in a database. Contractor Judicial Data is collected from one or more of the data sources and stored in a database. A number of external data sources having a plurality of variables, each variable having at least two values, are identified for use in generating the predictive statistical model.

The Contractor data could be stored on a relational database as shown in FIG. A2. Some well known are IBM, Microsoft Corp. Oracle, etc. associated with a computer system running the computational hardware and software applications necessary to generate the Contractor Risk Assessment Score.

The Contractor Risk Assessment Score data is digitized and assigned a weightage score (Table 1). This step may also include the creation of new variables, which are combinations of or derived from the algorithmic formula and software. For example, the external data source of Dun & Bradstreet provides the external variable, annual sales, years in business and Corporation structure, by extracting several years of annual sales for CRAS, that Contractors change in annual sales from year-to-year may be easily calculated and treated as a new or additional variable not otherwise available fro the external data source.

Additional statistical analysis is also performed to identify any algorithmic relationship between one or more external variable taken from the external data sources that may be related to the cumulative Contractor Risk Assessment Score for the defined Contractor as evidenced by the possible relationship to variables that are themselves known to be related to, and associated with, the cumulative loss ratio for the defined Contractor.

With the data stream built for each Contractor variables, the significance of the relationship between the one or more external variable and cumulative Contractor Risk Assessment Score is determined by the software system. Based on the critical weightage of the algorithm, individual external variables will be selected for generating the predictive model.

After the individual external variables have been validated as targeted as being significant, these variables are cross-references against one another. To the extent cross-correlation is present between, for example, one Contractor in two Counties. The Administrator my elect to discard one external variable of the pair of external variables showing cross-correlation.

The step in the process for generating the predictive statistical Contractor Risk Assessment Score based on external Data and score calculation are generally depicted. The data is split into multiple separate subsets of data on a random or otherwise statically significant basis, which is determined by the Algorithm. The data is split into a training data set; test data set and validation data set. This is essentially the last step before developing the score. The work data has been calculated and external variables predictive have been initially defined.

The task of developing the CRAS is begun using the working data set. As part of the same process, the test data set is used to evaluate the efficiency of the CRAS. The work data is derived and a calculation is made for each Construction Contractor.

Specifically, the validation data set is scored using the predictive statistical model developed. The Construction contractor in the validation data set is sorted by the score assigned to each by the predictive statistical model. The cumulative ratio is calculated using the work data derived and calculated for each group to provide an average score for each group of Construction Contractors.

In calculating the score of a Construction Contractor, the predictive statistical model developed and validated is used. First the data for the predictive variables that comprise the statistical model are gathered from the external data sources. Based on these values, the predictive statistical model generates a score. This score can then be gauged in order to make a profitability and Risk Assessment as to the delivery competency of the Construction Contractor.

In the preferred embodiment of the present invention, actual historical score data for Construction Contractors are derived or calculated from the historical Construction Contractor external data sources, U.S. Government agencies, (the “Entities”). Preferably, several years of data is gathered and pooled together in a single database (the “Company” database) as records. Other related information on each Construction Contractors is also gathered and pooled into the Company database, i.e. the Corporation Structure, address, zip code, type of Contractor License, Bonds placed and Amounts of Bonds, number of employees, Federal Employee Number, etc. This information is critical in associating a Construction Contractor's data with the predictive variables obtained from the external data sources.

External data aggregation is a rapidly expanding field. Numerous vendors are constantly developing new external data base. According to a preferred embodiment of the present invention, the external data sources include, but are not limited to the following described external data sources. Of significant importance are individual business level databases such as Dun & Bradstreet (D&B), TransUnion, Equifax and Experian data. Variables selected from the business level databases are matched to the data held in the Company database electronically based on the Construction Contractor License number and State of the contractor. A more accurate keyed matches may be employed whenever an external data provider's unique data key is present in the data sources, i.e. DUNS number is present in the Company database allowing the data to be matched to a specific record in the D&B database based on the D&B DUNS number.

Included as an external data source is third party vendor data available from Financial institutions and Bank, specifically Construction Loan Lenders. Such data is matched to the Company database electronically based on the Construction Contractors License number and state in which the contractor is licensed. County level data is also available and will include such information as number of Liens filled and settled, Fictitious Business data, Building Permit Data, Official Record Data, City Building Permit Data, City Fictitious Business Data, Department of Justice data etc. In the preferred embodiment of the present invention, all data regarding the Construction Contractor is rolled up into one database and matched.

External data sources also include Insurance company data such as State Farm, Farmers or First American. These data providers offer many characteristics of a Construction Contractor business claim data i.e. number of claims, site address of Job, amount of claim, date of claim, etc. The data is based on the business owner's name, address, and when available License Number or Social Security number. Other business data sources are also included when available. These include a non-corporation Construction Contractors individual credit report, which are available from data aggregators.

The Contractor uses CRASS to Market his/her company showing Strength for completion of engagements, Success of Completing Projects on time. The Contractor can also use to the calculated score to negotiate the interest rate with Banks and Financial Institutions. The Contractor can negotiate the Insurance Premiums based on the cumulative ratio generated by the CRAS. He can gage the quality of Sub-Contractors or Specialty Contractors that are going to work on the Job site. This will allow a more standardized method of accountability.

The Individual Home Builder (IHB) will use CRASS, would be able to make a decision based on a numerical score rating the quality of the Contractor he/she is considering hiring. Can judge the cost associated with the Bid from the Contractor. The IHB can use CRASS to weight the quality assurance can act as a General Contractor. The IHB can negotiate the interest rate associated with the potential construction project from a Financial Institution or Bank. The IHB can negotiate the insurance premiums associated with construction projects from the Insurance Company. The IHB can insist on using only certain preferred Contractors.

What is claimed:

1. A system for providing a contactor risk assessment score (CRAS), comprising:
A memory for storing data,
A computer coupled to said memory and
A program in execution by said computer,
said program comprising a formula comparing variables predictive of a performance of a contractor.

2. The system of claim 1, wherein the formula is
CRAS=[ε(Ai)/ε(Mi)*100]
where Ai=Assigned score on variable i; and Mi=maximum score on variable i.

3. The system of claim 2, wherein the contractor is a construction contractor.

4. The system of claim 3, wherein the formula determines a sum of assigned scores on said variables.

5. The system of claim 4, wherein the variables comprise a payment history value based on payments by the contractor and a credit history value of the contractor.

6. The system of claim 5, wherein the variables further comprise a value for an amount owed in debt by the contractor.

7. The system of claim 5, wherein the variables further comprise at least one predefined criterion selected from the group consisting of: a Risk Assessment metric having changed by at least a predetermined amount and a length of time since a transmitted alert.

8. The system of claim 5, wherein the variables further comprise at least one predefined criterion selected from the group consisting of: length-of-license, Cumulative-total-of-engagements, number-of-Notice-of-completions, Number-of-terminations, Current-engagements, Insurance-held divided by Total-value-of-engagement, Company-structure, number-of-employees, years-in-trade, number-of-liens, Number-of-banks-used, Terminations divided by Years-in-trade, Terminations divided by Total-Engagements, Delays divided by Total-Engagements, Number-of-Tax-Liens, Age-of-Contractor, License-Type, License-Status, Repeat Business-with-Bank, Average-size-of-Engagement, Judgments, and Judgments-satisfied.

9. The system of claim 1, further comprising a score history report. The Score History Report is a report generated on a unique desired variable such as months. The software can generated a report based on the months of a predefined time span.

10. The system of claim 1, wherein the formula generates a score using multivariate methods to produce a coefficient for an external variable and the coefficient represents the contribution the external variable to the CRAS.

11. A method for providing a contactor risk assessment score (CRAS), comprising:
storing data in a memory coupled to a computer
executing a program by said computer,
said program comprising a formula comparing variables predictive of a performance of a contractor.

12. The method of claim 11, wherein the formula is
CRAS=[ε(Ai)/ε(Mi)*100]
where Ai=Assigned score on variable i; and Mi=maximum score on variable i.

13. The method of claim 12, wherein the contractor is a construction contractor.

14. The method of claim 13, wherein the formula determines a sum of assigned scores on said variables.

15. The method of claim 14, wherein the variables comprise a payment history value based on payments by the contractor and a credit history value of the contractor.

16. The method of claim 15, wherein the variables further comprise a value for an amount owed in debt by the contractor.

17. The method of claim 15, wherein the variables further comprise at least one predefined criterion selected from the group consisting of: a Risk Assessment metric having changed by at least a predetermined amount and a length of time since a transmitted alert.

18. The method of claim 15, wherein the variables further comprise at least one predefined criterion selected from the group consisting of: length-of-license, Cumulative-total-of-engagements, number-of-Notice-of-completions, Number-of-terminations, Current-engagements, Insurance-held divided by Total-value-of-engagement, Company-structure, number-of-employees, years-in-trade, number-of-liens, Number-of-banks-used, Terminations divided by Years-in-trade, Terminations divided by Total-Engagements, Delays divided by Total-Engagements, Number-of-Tax-Liens, Age-of-Contractor, License-Type, License-Status, Repeat Business-with-Bank, Average-size-of-Engagement, Judgments, and Judgments-satisfied.

19. The method of claim 11, further comprising generating a score history report.

20. The method of claim 11, wherein the formula generates a score using multivariate methods to produce a coefficient for an external variable and the coefficient represents the contribution the external variable to the CRAS.

21. The method of claim 11, further comprising examining external variables for cross-correlation against one another to validate the external variables.

22. The method of claim 21, further comprising associating at least one individual external variable with an individual contractor's records based on a data key associated with at least one external data source.

23. The method of claim 11, further comprising dividing the data into a relational data set for developing the score for refining and validating the data.
